(19) United States
(12) Patent Application Publication
(10) Pub. No.: US 2015/0379571 A1
(43) Pub. Date: Dec. 31, 2015

(54) SYSTEMS AND METHODS FOR SEARCH RETARGETING USING DIRECTED DISTRIBUTED QUERY WORD REPRESENTATIONS

(71) Applicant: YAHOO! Inc., Sunnyvale, CA (US)

(72) Inventors: Mihajlo Grbovic, Mountain View, CA (US); Nemanja Djuric, Mountain View, CA (US); Vladan Radosavljevic, Sunnyvale, CA (US); Narayan Bhamidipati, Santa Clara, CA (US)

(73) Assignee: YAHOO! Inc., Sunnyvale, CA (US)

(21) Appl. No.: 14/320,048

(22) Filed: Jun. 30, 2014

(51) Int. Cl. G06Q 30/02; G06F 17/30

(52) U.S. Cl. CPC G06Q 30/0256; G06F 17/30598; G06F 17/30864

(57) ABSTRACT

A system stored in a non-transitory medium executable by processor circuitry is provided for generating retargeting keywords based on distributed query word representations. The system includes one or more system databases storing historical web search data. Search retargeting circuitry receives requests to generate sets of retargeting keywords related to one or more categories of an advertisement campaign and pre-processing circuitry retrieves a set of historical web search data related to the one or more categories of the advertisement campaign. Modeling circuitry further applies one or more computational linguistic models to the retrieved set of historical web search data and generates distributed query word representations from the retrieved set of historical web search data. Keyword generator circuitry generates a list of retargeting keywords related to the one or more categories of the advertisement campaign using the generated distributed query word representations.

### TECHNICAL FIELD

The present description relates generally to systems and methods, generally referred to as a system, for search retargeting using directed distributed query word representation. In particular, the present description relates to deep learning technologies utilizing distributed representations of query words to generate adwords for search retargeting.

### BACKGROUND

It is common for users to enter a query consisting of one or more keywords and execute a search on a web page. Typically, online marketers will target those users with search advertising by interposing advertisements within the results generated by search engines. In addition to search advertising, some online marketers may seek to target users based on previous searches or keywords that the users have entered on other websites using search retargeting.

Traditional search retargeting techniques require an advertiser to generate ad campaigns and to specify lists of retargeting keywords for each campaign or category of campaigns. The online marketers may then retarget queries entered by users by matching the user queries against the list of retargeting keywords specified by the advertiser. However, these traditional techniques for search retargeting are inherently limited by the requirement that the particular query word entered by the user, or a portion thereof, be present in the list of retargeting keywords specified by the advertisers. A large percentage of advertisers, however, provide an incomplete list of retargeting keywords. There exists set of engineering problems to be solved in order to accurately extend traditional search retargeting techniques to scenarios when retargeting keywords are either incomplete or unknown.

Moreover, advertisers often specify a single set of keywords for an entire category of advertising campaigns, such as travel-based campaigns, for example. While these keyword sets are typically related to the general category of advertisement, the lists are generalized and are not adequately tailored in order to efficiently capture retargeting opportunities on a per ad basis. This necessarily results in lost monetization and conversion opportunities. Consequently, there exists a second set of engineering problems to be solved in order to generate tailored keyword lists and to adequately capture search retargeting opportunities.

### SUMMARY

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

In one aspect or embodiment, a system stored in a non-transitory medium executable by processor circuitry is provided for generating retargeting keywords based on distributed query word representations. The system includes one or more system databases storing historical web search data. Search retargeting circuitry receives requests to generate sets of retargeting keywords related to one or more categories of an advertisement campaign and pre-processing circuitry retrieves a set of historical web search data related to the one or more categories of the advertisement campaign. Modeling circuitry further applies one or more computational linguistic models to the retrieved set of historical web search data and generates distributed query word representations from the retrieved set of historical web search data. Keyword generator circuitry generates a list of retargeting keywords related to the one or more categories of the advertisement campaign using the generated distributed query word representations.

In another aspect or embodiment, a computer-implemented method is provided for a computer-implemented method for generating retargeting keywords. The method includes processing, by search retargeting circuitry communicatively coupled to a network communications circuitry, a request to generate sets of retargeting keywords related to an advertisement campaign. The method further includes processing, by pre-processing circuitry, the request to retrieve a set of historical web search data related to the advertisement campaign and generating, by modeling circuitry, distributed query word representations from the retrieved set of historical web search data by applying one or more natural language processing models to the set of historical web search data. The method further includes generating, by keyword generator circuitry, a list of retargeting keywords related to the advertisement campaign based on the distributed query word representations.

In a third aspect or embodiment, a system is provided that includes a means for generating search retargeting keywords and includes a means for receiving a request to generate retargeting keywords for an advertisement campaign. The system further includes a means for processing the request to identify historical web search data related to the advertisement campaign and a means for generating distributed query word representations from the identified historical web search data by applying one or more natural language processing models to the identified historical web search data that considers user actions within a predetermined timeframe of an ad click. The system also includes a means for generating a list of retargeting keywords related to the advertisement campaign based on the distributed query word representations.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 illustrates a block diagram of an information system depicting exemplary devices of an exemplary network for implementing various aspects of a search retargeting framework using directed distributed query word representations.

FIG. 2 illustrates a block diagram of one embodiment of a keyword vector generating circuitry.

FIG. 3 illustrates a block diagram of one embodiment of exemplary monetization circuitry of a search retargeting server.

FIG. 4 illustrates exemplary operations according to one embodiment that may be performed by the circuitry of a search retargeting server in an exemplary system in order to generate distributed query representations to be used for search retargeting.

FIGS. 5a and 5b illustrates exemplary operations according to one embodiment that may be performed by the circuitry of a search retargeting server in an exemplary system in order to generate distributed query representations to be used for search retargeting and keyword generation.

FIG. 6 illustrates a block diagram of exemplary circuitry of a server in an exemplary system according to one embodiment that can provide aspects of the search retargeting framework.

FIG. 7 illustrates a block diagram of an exemplary electronic device for implementing various server-side aspects of the search retargeting framework for building keyword lists utilizing distributed query representations.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

### Overview

By way of introduction, novel systems and methods related to search retargeting using distributed query word representations and monetization elements are described herein. Also described herein are novel systems, methods, and circuitry related to sponsorship and monetization techniques for search retargeting using keyword lists generated from the directed distributed query word representations. In one aspect, systems and methods in accordance with the present description utilize historical web search activity to build or generate keyword lists that can be used to develop rules for search retargeting in an improved and novel manner.

Search retargeting (SRT) is a type of rule-based ad targeting, where the campaign audience is manually selected by enforcing a small set of rules related to search activity of the user. In a typical scenario, an advertiser builds a custom set of keywords based on their market research, or uses a standard set of keywords for a category associated with an campaign, such as a list of travel related ad words for campaigns having a relationship to travel for example. The advertiser may then want to show travel related advertisements to all users that search for the related ad words in the list, such as “airplane tickets,” “hotels,” “car rental,” and so forth.

Traditional solutions for search retargeting systems require an advertiser to manually generate these keyword lists for its ad campaigns. Moreover, advertisers traditionally have to create individual lists for each category of advertisement campaign, or set of campaigns, that are related to different topics. In order to become provide more targeted rules for SRT, advertisers have to manually create ad campaigns tailored for each individual category or topic and sub-topic. In addition to being a time-consuming, cumbersome task, the keyword lists traditionally generated by advertisers are often incomplete, inaccurate, and untailored at a per-advertisement level. In other words, similar or identical keyword lists are often used for entire sets of campaigns in order to save on the time-intensive labor of generating targeted lists. Moreover, these traditional techniques are inherently susceptible to inaccurate search retargeting and missed conversion opportunities or opportunities to show ads to relevant users who actually searched for keywords related to the ad campaign but that did not match a keyword in the list generated by the advertisers. Often advertisers will miss conversion opportunities because the query term entered by the user was not anticipated by the advertisers, despite that it may have actually been relevant to the advertiser's campaign.

Various embodiments in accordance with the present description provide novel engineering solutions to address these and other technical problems inherent in traditional search retargeting. In particular, certain embodiments are directed systems and methods for generating data-driven keyword clusters using distributed query word representations formed from novel techniques for analyzing and processing historical web search activity, including, by way of illustration, historical search queries entered by users, historical advertising campaigns, recorded ad clicks or interactions, ad impressions, and resulting ad conversions, for example. Keyword cluster sets or keyword lists for a specific advertiser or campaign type may be generated by learning distributed representations of user queries that are most likely to lead to ad clicks and conversions. In some embodiments, the distributed representation may be generated by applying a directed approach to learning distributed representations that focuses on or weights the data to emphasize actions immediately preceding an ad click. For example, by using deep learning technologies, the circuitry components of the present system generate distributed representations of query words in vector space using the search engine data, such that similar words in context of web search (i.e., those that are most likely to lead to ad clicks) can be found in a cluster K of the nearest neighbors of an adword or keyword category.

By generating lists of those keywords or adwords which are most likely to result in an ad click, systems and methods implemented in accordance with the present description can be used to expand existing campaign keywords or to generate related keywords lists or sets from scratch. In the latter scenario, the system circuitry is able to start with a simple ad category, or even the name of the advertiser, and may then extrapolate this information in order to generate a cluster K most related adwords and keywords that can be used for rule-based search retargeting for that advertiser. This is particularly well-suited to advertisers wishing provide highly focused keyword lists or adword sets that are tailored to specific ad types or categories, such as financial, retail, health, travel, and other targeting criteria or categories.

A producer, such as Yahoo!, for example, may leverage one or more databases of historical query and web search data to dynamically generate keyword lists, such as by using deep learning technologies, in some embodiments, for example, and corresponding search retargeting rules for particular advertisers or organizations to utilize in targeting users with tailored display ads. In some embodiments, search retargeting rules using the generated keyword lists may be based on site retargeting, which targets users that visited websites of certain companies, email retargeting, which targets users that received emails from certain companies or individuals, search retargeting, which targets users that searched certain keywords or entered the keywords on various webpages, and demographic targeting, which targets users based on age and gender or other profile and preference information determined for that user. The size of the targeted audience may be manipulated by adding or dropping rules in order to expand or narrow the range of the target audience. The search retargeting rules may involve additional requirements in terms of count and recency, such as the minimum number of keyword searches within a certain time period, thereby resulting in a more focused search retargeting rule set. By way of illustration, an automobile manufacturer may want to target all users that search for any of the keywords in a list generated for an automobile category, such as the manufacturer name or the automobile's make and model, and may wish to limit the search retargeting rules to users that conducted at least two searches for keywords related to the manufacturer or vehicle make and model within the past week, month, or year.

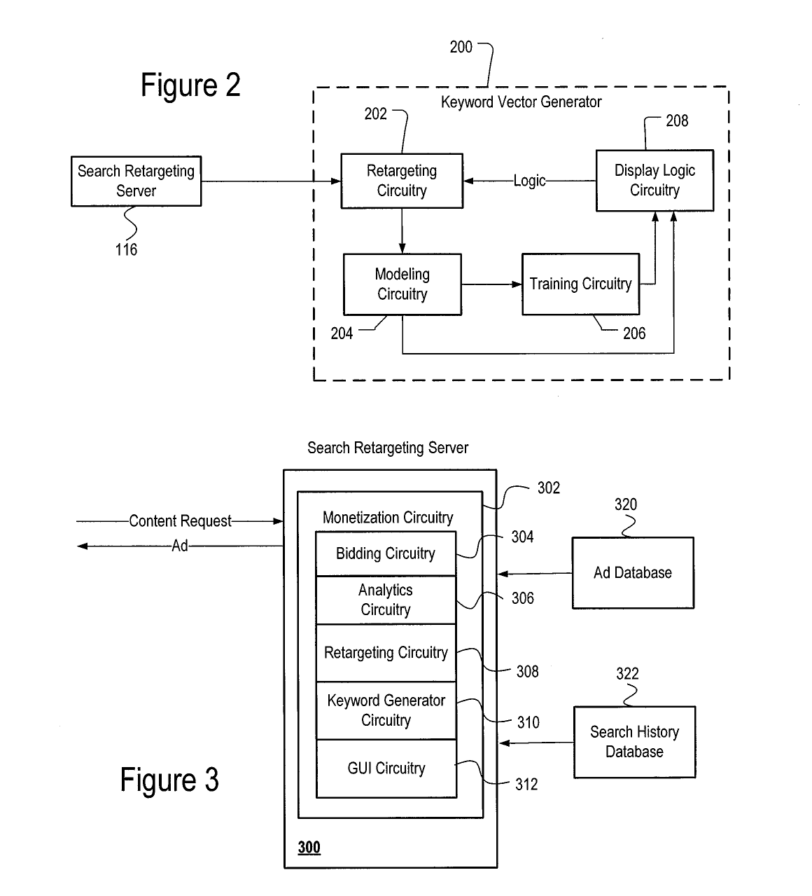

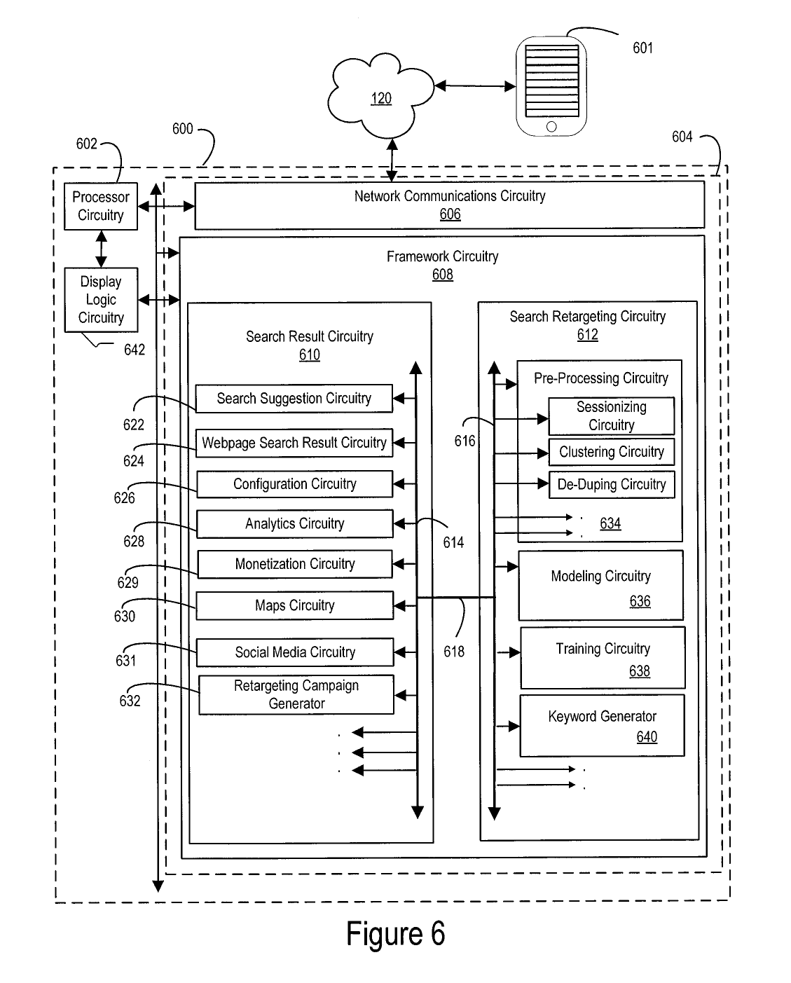

In other aspects of the present description, one or more databases are provided storing historical web search activity. The web search data is typically aggregated on a per user basis in order to form profiles for targeting. For example, raw activity logs of search queries with timestamps may be stored for every user. Given one or more search retargeting rules and a list of keywords generated by the system circuitry, such as by the circuitry components of keyword vector generator 200 of FIG. 2 or search retargeting circuitry 612 of FIG. 6, the system can determine whether a certain user qualities for the campaign by retrieving their search queries, including data such as, for example, that a user has searched for any of the keywords in the list c=1 or more times in previous t=10 days, where c and t may be variables of the campaign related to count and timeframe, respectively. For more involved use of timestamps, the counts may be weighted or discounted depending on how recently the activities happened, which is sometimes referred to herein as a “directed” approach. To achieve the desired reach, the number of users in the targeted segment, number of keywords, as well as parameters, such as c and t, may be tuned. These rule-based retargeting features are merely exemplary and other aspects of the retargeting systems and methods utilizing distributed query representations will become apparent to those having ordinary skill in the art in view of the following description of the Figures.

### DESCRIPTION OF THE DRAWINGS

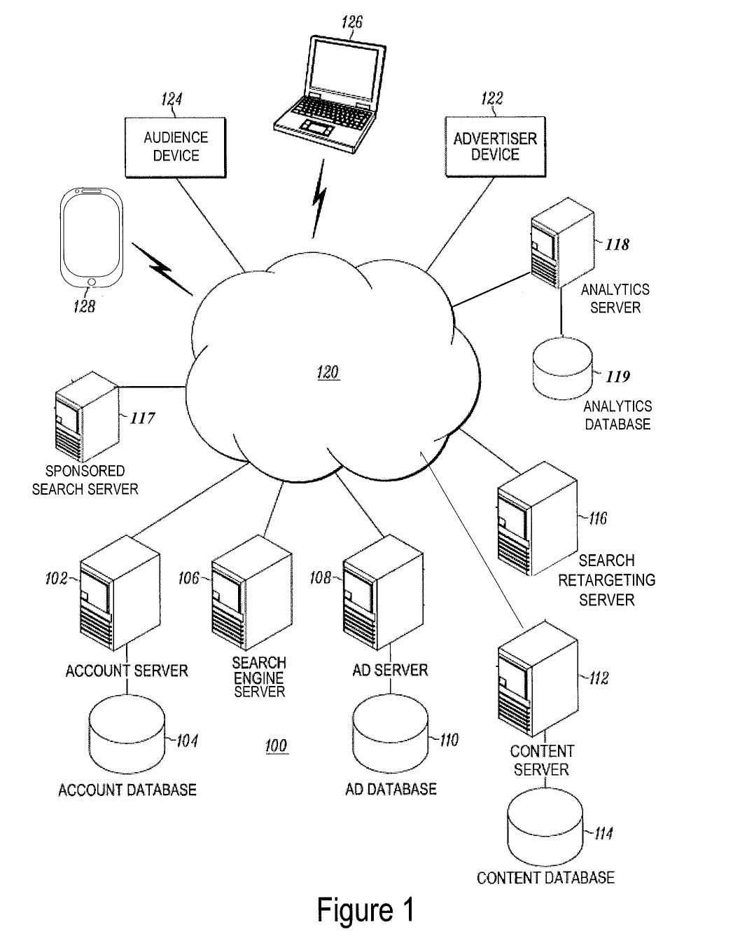

Referring now to the figures, FIG. 1 illustrates a block diagram of an information system 100 depicting exemplary devices of an exemplary network for implementing various aspects of a search retargeting framework using directed distributed query word representations. Search retargeting information using directed distributed query word representations is monetized when the keyword lists are generated by the system circuitry and used to select one or more display ads, for example, as well as other monetization schemes described herein. The information system 100 in the exemplary network of FIG. 1 includes an account server 102, an account database 104, a search engine server 106, an ad server 108, an ad database 110, a content database 114, a content server 112, a search retargeting framework server 116 (which can also be communicatively coupled with a corresponding database not pictured), a sponsored search server 117 (which may likewise be communicatively coupled with a corresponding database), an analytics server 118, and an analytics database 119. Various servers and databases of the aforementioned servers and databases may be the same server or database or may be one or more distributed databases and servers communicatively coupled over a network 120, which may be the Internet.

The information system 100 may be accessible over the network 120 by advertiser devices, such as an advertiser client device 122 and by audience devices, such as an audience client device 124. An audience device can be a client device or user device that presents online content, such as search results, search suggestions, content, and advertisements to a user, and may include both laptop computer 126 and smartphone 128. Search results can be monetized and/or sponsored using display ads or sponsored search results, as well as other monetization schemes, and the displayed ads or sponsored results can be selected using rule-based search retargeting utilizing keyword lists generated based on distributed query word representations. In various examples of such an online information system, users may search for and obtain content from sources over the network 120, such as obtaining content from the search engine server 106, the ad server 108, the ad database 110, the content server 112, the content database 114, the search retargeting framework server 116, and the sponsored search server 117. Advertisers may provide advertisements for placement on electronic properties, such as webpages, and other communications sent over the network to audience devices, such as the audience client device 124. The online information system can be deployed and operated by an online services provider, such as Yahoo! Inc.

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content. Also, examples include analytics data related to their ads and associated content and user interactions with the aforementioned. In an example, the analytics data may be in the form of one or more sketches, such as in the form of a sketch per audience segment, segment combination, or at least part of a campaign. The account information may include ad booking information. This booking information can be used as input for determining ad impression availability or as part of a bidding process.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser (such as a client-side application). The advertiser front end may be a program, application, or software routine that forms a user interface. In a particular example, the advertiser front end is accessible as a website with electronic properties that an accessing advertiser may view on an advertiser device, such as the advertiser client device 122. The advertiser may view and edit account data and advertisement data, such as ad booking data, using the advertiser front end. After editing the advertising data, the account data may then be saved to the account database 104.

Also, audience analytics, impressions delivered, impression availability, and segments may be viewed in real time using the advertiser front end. The advertiser front end may be a client-side application, such as a client-side application running on the advertiser client device. A script and/or applet (such as a script and/or applet) may be a part of this front end and may render access points for retrieval of the audience analytics, impressions delivered, impression availability, and segments. In an example, this front end may include a graphical display of fields for selecting an audience segment, segment combination, or at least part of a campaign. The front end, via the script and/or applet, can request the audience analytics, impressions delivered, and impression availability for the audience segment, segment combination, or at least part of a campaign. The information can then be displayed, such as displayed according to the script and/or applet.

The search engine server 106, the search retargeting framework server 116, the sponsored search server 117, or any combination thereof may be a single server or one or more servers in operative communication a network. Alternatively, the search engine server 106, the search retargeting framework server 116, the sponsored search server 117, or any combination thereof may be a computer program, instructions, or software code stored on a non-transitory computer-readable storage medium that runs on one or more processors or system circuitry of one or more servers. The search engine server 106, the search retargeting framework server 116, the sponsored search server 117, or any combination thereof may be accessed by audience devices, such as the audience client device 124 operated by an audience member over the network 120. Access may be through graphical access points. For example, query entry boxes of a webpage may be an access point for the user to submit a search query to the search engine server 106, the search retargeting framework server 116, the sponsored search server 117, or any combination thereof, from the audience client device 124. Search queries submitted or other user interactions with such servers can be logged in data logs, and such logs may be communicated to the analytics server 118 for processing. After processing, the analytics server 118 can output corresponding analytics data to be served to the search engine server 106, the search retargeting framework server 116, the sponsored search server 117, or any combination thereof for determining sponsored and non-sponsored search results, as well as other types of content and ad impressions. Analytics circuitry (such as analytics circuitry 628 of FIG. 6) may be used to determine the relevant analytics data, and such circuitry may be embedded in any one of the servers and client devices illustrated in FIG. 1.

Besides a search query, the audience client device 124 can communicate interactions with a search result and/or a search suggestion, such as interactions with a sub-GUI or modular component associated with the search result appearing on the same page view as the search result. Such interactions can be communicated to any one of the servers illustrated in FIG. 1, for example. The search engine server 106, the search retargeting framework server 116, the sponsored search server 117, or any combination thereof can locate information matching the queries and the interactions using a suitable protocol or algorithm and return the matching information to the audience client device 124, such as in the form of search suggestions, monetized and/or sponsored search results, associated GUIs, and any combination thereof. Webpage search results may include a link to a corresponding webpage and a short corresponding blurb and/or text scraped from the webpage. Search suggestion results may include sponsored or non-sponsored search results that are determined to likely be of interest of to the user. The search engine server 106, the search retargeting framework server 116, the sponsored search server 117, or any combination thereof, may receive user interaction information, that can include search queries, from an audience device, and send corresponding information to the ad server 108 and/or the content server 112, and the ad server 108 and/or the content server 112 may serve corresponding ads and/or search results, but with more in-depth details or accompanying GUIs and sub-GUIs for interacting with subject matter associated with ads or other sponsored content. The information inputted and/or outputted by these devices may be logged in data logs and communicated to the analytics server 118 over the network 120 for processing by the analytics circuitry. The analytics server 118 and related circuitry can provide analyzed feedback for affecting future serving of content. For example, the analytics server 118 and associated circuitry can provide feedback for affecting serving of ads, search suggestions, sponsored and non-sponsored search result, ad content, and the respective GUIs and sub-GUIs included with and/or associated with the ads, search suggestions, sponsored and non-sponsored search results, or any combination thereof.

The search engine server 106, the search retargeting framework server 116, the sponsored search server 117, or any combination thereof may be designed to help users and potential audience members find information located on the Internet or on an intranet. In an example, these servers or any combination thereof may also provide to the audience client device 124 over the network 120 an electronic property, such as a webpage and/or entity tray, with content, including search results, ads, information matching the context of a user inquiry, links to other network destinations, or information and files of information of interest to a user operating the audience client device 124, as well as a stream or webpage of content items and advertisement items selected for display to the user. The aforementioned provided properties and information, solely or in any combination, may be monetized and/or sponsored. The aforementioned properties and information provided by these servers or any combination thereof may also be logged, and such logs may be communicated to the analytics server 118 for processing, over the network 120. Once processed into corresponding analytics data, the analytics server 118 and associated circuitry can provide analyzed feedback for affecting future serving of content.

The search engine server 106, the search retargeting framework server 116, the sponsored search server 117, or any combination thereof may enable a device, such as the advertiser client device 122, the audience client device 124, or another type of client device, to search for files of interest using a search query. Typically, these servers or any combination thereof may be accessed by a client device over the network 120. These servers or any combination thereof may include a crawler component, an indexer component, an index storage component, a search component, a ranking component, a cache, a user or group profile storage component, an sponsored content component, a logon component, a user or group profile builder, an entity builder, a modeling, an analytics component, and application program interfaces (APIs), such as APIs corresponding with the search framework for utilizing search retargeting rules generated using distributed query word representations. These servers or any combination thereof may be deployed in a distributed manner, such as via a set of distributed servers, for example. Components may be duplicated within a network, such as for redundancy or better access.

The ad server 108 operates to serve advertisements to audience devices, such as the audience client device 124. An advertisement may include text data, graphic data, image data, video data, or audio data. Advertisements may also include data defining advertisement information that may be of interest to a user of an audience device. The advertisements may also include respective audience targeting information or ad campaign information, such as information on audience segments and segment combinations. An advertisement may further include data defining links to other online properties reachable through the network 120, such as to sponsored and non-sponsored search results. Also, ad content may be or include an advertisement link or related GUI generated for displaying an advertisement. The aforementioned audience targeting information and the other data associated with an ad may be logged in data logs and such logs may be communicated to the analytics server 118 for processing. Once processed into corresponding analytics data, the analytics server 118 can provide analyzed feedback for affecting future serving of content, such as monetized and/or sponsored content, including sponsored verbs and/or contexts.

For online service providers, advertisements may be displayed on electronic properties resulting from a user-defined search based, at least in part, upon search terms. Advertising may be beneficial to users, advertisers or web portals if displayed advertisements are relevant to audience segments, segment combinations, or at least parts of campaigns. Thus, a variety of techniques have been developed to determine corresponding audience segments or to subsequently target relevant advertising to audience members of such segments. For example user interests, user intentions, and targeting data related to segments or campaigns may be may be logged in data logs and such logs may be communicated to the analytics server 118 for processing. Once processed into corresponding analytics data, the analytics server 118 can provide analyzed feedback for affecting future serving of content.

One approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. The aforementioned targeting data, such as demographic data and psychographic data, may be logged in data logs and such logs may be communicated to the analytics server 118 for processing. Once processed into corresponding analytics data, the analytics server 118 can provide analyzed feedback for affecting future serving of content.

Another approach includes profile-type ad targeting. In this approach, user or group profiles specific to a respective user or group may be generated to model user behavior, for example, by tracking a user's path through a website or network of sites, and compiling a profile based, at least in part, on ad GUIs, webpages, and advertisements ultimately delivered. A correlation may be identified, such as for user purchases, for example. An identified correlation may be used to target potential purchasers by targeting content or advertisements to particular users. The aforementioned profile-type targeting data may be logged in data logs and such logs may be communicated to the analytics server 118 for processing. Once processed into corresponding analytics data, the analytics server 118 can provide analyzed feedback for affecting future serving of content.

The ad server 108 includes logic and data operative to format the advertisement data for communication to a user device, such as an audience member device. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs and such logs may be communicated to the analytics server 118 for processing. Once processed into corresponding analytics data, the analytics server 118 can provide analyzed feedback for affecting future serving of content.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look and feel for advertising items in the stream. Such a stream may be included in or combined with an search result GUI. Also, sponsored ad GUIs and sub-GUIs, opposed to non-sponsored GUIs and sub-GUIs, can include a similar appearance, size, shape, text formatting, graphics formatting, or combination thereof to provide a consistent look and feel between each other and/or a sponsored stream. Additionally, data related to the aforementioned formatting may be logged in data logs and such logs may be communicated to the analytics server 118 for processing. Once processed into corresponding analytics data, the analytics server 118 can provide analyzed feedback for affecting future serving of content.

Further, the ad server 108 is in data communication with the network 120. The ad server 108 communicates ad data and other information to devices over the network 120. This information may include advertisement data communicated to an audience device. This information may also include advertisement data and other information communicated with an advertiser device, such as the advertiser client device 122. An advertiser operating an advertiser device may access the ad server 108 over the network to access information, including advertisement data. This access may include developing advertisement creatives, editing advertisement data, deleting advertisement data, setting and adjusting bid amounts and other activities. This access may also include a portal for interacting with, viewing analytics associated with, and editing parts of ad GUIs. The ad server 108 then provides the ad items and/or ad GUIs to other network devices, such as the search retargeting framework server 116, the analytics server 118, and/or the account server 102, for classification (such as associating the ad items and/or GUIs with audience segments, segment combinations, or at least parts of campaigns). This information can be used to provide feedback for affecting serving of ads, search suggestions, sponsored and non-sponsored search results, ad content, respective GUIs and sub-GUIs included with and/or associated with the search suggestions, sponsored and non-sponsored search results, ad content, or any combination thereof.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device.

The ad server 108, the content server 112, or any other server described herein may be a single server or one or more distributed servers in data communication over a network. Alternatively, the ad server 108, the content server 112, or any other server described herein may be a computer program, instructions, and/or software code stored on a non-transitory computer-readable storage medium that runs on one or more processors of one or more servers. The ad server 108 may access information about ad items either from the ad database 110 or from another location accessible over the network 120. The ad server 108 communicates data defining ad items and other information to devices over the network 120. The content server 112 may access information about content items either from the content database 114 or from another location accessible over the network 120. The content server 112 communicates data defining content items and other information to devices over the network 120. Content items and the ad items may include any form of content included in ads, search suggestions, sponsored and non-sponsored search results, respective GUIs and sub-GUIs included with and/or associated with the ads, search suggestions, sponsored and non-sponsored search results, or any combination thereof.

The information about content items may also include content data and other information communicated by a content provider operating a content provider device, such as respective audience segment information and possible links to sponsored and non-sponsored search results or web pages and other types of ad GUIs. A content provider operating a content provider device may access the content server 112 over the network 120 to access information, including the respective search result and search suggestion information. This access may be for developing content items, editing content items, deleting content items, setting and adjusting bid amounts and other activities, such as associating content items with audience segments, segment combinations, or at least parts of campaigns. A content provider operating a content provider device may also access the analytics server 118 over the network 120 to access analytics data. Such analytics may help focus developing content items, editing content items, deleting content items, setting and adjusting bid amounts, and activities related to distribution of the content, such as distribution of content via monetized and sponsored search results and GUIs.

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120, such as devices administering monetized and sponsored search results and GUIs.

The content provider front end may be a client-side application, such as a client-side application running on the advertiser client device or the audience client device, respectively. A script and/or applet, such as the script and/or applet, may be a part of this front end and may render access points for retrieval of impression availability data (such as the impression availability data), and the script and/or applet may manage the retrieval of the impression availability data. In an example, this front end may include a graphical display of fields for selecting audience segments, segment combinations, or at least parts of campaigns. Then this front end, via the script and/or applet, can request the impression availability for the audience segments, segment combinations, or at least parts of campaigns. The analytics can then be displayed, such as displayed according to the script and/or applet. Such analytics may also be used to provide feedback for affecting serving of ads, search suggestions, sponsored and non-sponsored search results, ad content, respective GUIs and sub-GUIs included with and/or associated with the ads, search suggestions, sponsored and non-sponsored search results, GUIs and sub-GUIs, and any combination thereof.

The content server 112 includes logic and data operative to format content data for communication to the audience device. The content server 112 can provide content items or links to such items to the analytics server 118 and/or the search retargeting framework server 116 for analysis or associations with entities. For example, content items and links may be matched to data, such as by analytics circuitry 628 or monetization circuitry 630 of FIG. 6. The matching may be complex and may be based on historical information related to the audience segments and impression availability.

In an example, the content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs and such logs may be communicated to the analytics server 118 for processing. Once processed into corresponding analytics data, the analytics server 118 can provide analyzed feedback for affecting future serving of content.

The aforementioned servers and databases may be implemented through a computing device. A computing device may be capable of sending or receiving signals, such as over a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views, search results, ad content, and their respective GUIs, or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). Such sites may be integrated with the framework via the search retargeting framework server 116. An online server system may also host a variety of other sites, including, but not limited to business sites, educational sites, dictionary sites, encyclopedia sites, wikis, financial sites, government sites, etc. These sites, as well, may be integrated with the framework via the search retargeting framework server 116.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, may employ differing architectures or may be compliant or compatible with differing protocols, and may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

The advertiser client device 122 includes a data processing device that may access the information system 100 over the network 120. The advertiser client device 122 is operative to interact over the network 120 with any of the servers or databases described herein. The advertiser client device 122 may implement a client-side application for viewing electronic properties and submitting user requests. The advertiser client device 122 may communicate data to the information system 100, including data defining electronic properties and other information. The advertiser client device 122 may receive communications from the information system 100, including data defining electronic properties and advertising creative and one or more categories for each creative. The aforementioned interactions and information may be logged in data logs and such logs may be communicated to the analytics server 118 for processing. Once processed into corresponding analytics data, the analytics server 118 can provide analyzed feedback for affecting future serving of content.

In an example, content providers may access the information system 100 with content provider devices that are generally analogous to the advertiser devices in structure and function. The content provider devices provide access to content data in the content database 114, for example.

The audience client device 124 includes a data processing device that may access the information system 100 over the network 120. The audience client device 124 is operative to interact over the network 120 with the search engine server 106, the ad server 108, the content server 112, and the analytics server 118, and the search retargeting framework server 116. The audience client device 124 may implement a client-side application for viewing electronic content and submitting user requests. A user operating the audience client device 124 may enter a search request and communicate the search request to the information system 100. The search request is processed by the search engine and search results are returned to the audience client device 124. The aforementioned interactions and information may be logged in data logs and such logs may be communicated to the analytics server 118 for processing. Once processed into corresponding analytics data, the analytics server 118 can provide analyzed feedback for affecting future serving of content.

In other examples, a user of the audience client device 124 may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device 124. The aforementioned interactions and information may be logged in data logs and such logs may be communicated to the analytics server 118 for processing. Once processed into corresponding analytics data, the analytics server 118 can provide analyzed feedback for affecting future serving of content.

The advertiser client device 122 and the audience client device 124 operate as a client device when accessing information on the information system 100. A client device, such as the advertiser client device 122 and the audience client device 124 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the foregoing devices, or the like. In the example of FIG. 1, both laptop computer 126 and smartphone 128, which can be client devices or audience devices, may be operated as either an advertiser device or an audience device.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device, such as the advertiser client device 122 and the audience client device 124, may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or video games. The foregoing is provided to illustrate that claimed subject matter is intended to include a wide range of possible features or capabilities. At least some of the features, capabilities, and interactions with the aforementioned may be logged in data logs and such logs may be communicated to the analytics server 118 for processing. Once processed into corresponding analytics data, the analytics server 118 can provide analyzed feedback for affecting future serving of content. Also, the described methods and systems may be implemented at least partially in a cloud-computing environment, at least partially in a server, at least partially in a client device, or in any combination thereof.

FIG. 2 illustrates a block diagram of circuitry components of a sponsored verb generator according to some embodiments. Keyword vector generator 200 may be communicatively coupled search retargeting framework server 116 and may include retargeting circuitry 202, modeling circuitry 204, training circuitry 206, and/or display logic circuitry 208 components. Search retargeting framework server 116 may receive a search query to from a user device and determine one or more search suggestions, sponsored or non-sponsored search results, advertisements, or other related ad content to display to the user. For each search query entered by the user, search retargeting framework server 116 may seek to identify opportunities for monetization, including by using search retargeting rules for keyword lists that have been generated by keyword vector generator 200 using directed distributed query word representations. Search retargeting framework server 116 will communicate the requests containing search query words to keyword vector generator 200. The request will be received by keyword vector generator 200 and retargeting circuitry 202 will determine one or retargeting rules to be used in selecting an advertisement or sponsored content for display to the user request. The advertisement or sponsored content components may include one or more sub-GUIs that are generated by or associated with the search result generated by the search result circuitry, such as various circuitry components of the search result circuitry framework 610 and described in connection with FIG. 6. The search result circuitry framework (e.g., search suggestion circuitry, webpage search result circuitry, configuration circuitry, analytics circuitry, monetization circuitry, maps circuitry, social media circuitry, and retargeting campaign generator) will generate search result content to display to the user. User interactions with the search result content, including ad impressions and ad clicks, are stored by the search retargeting server 116 and communicated to the keyword vector generator 200.

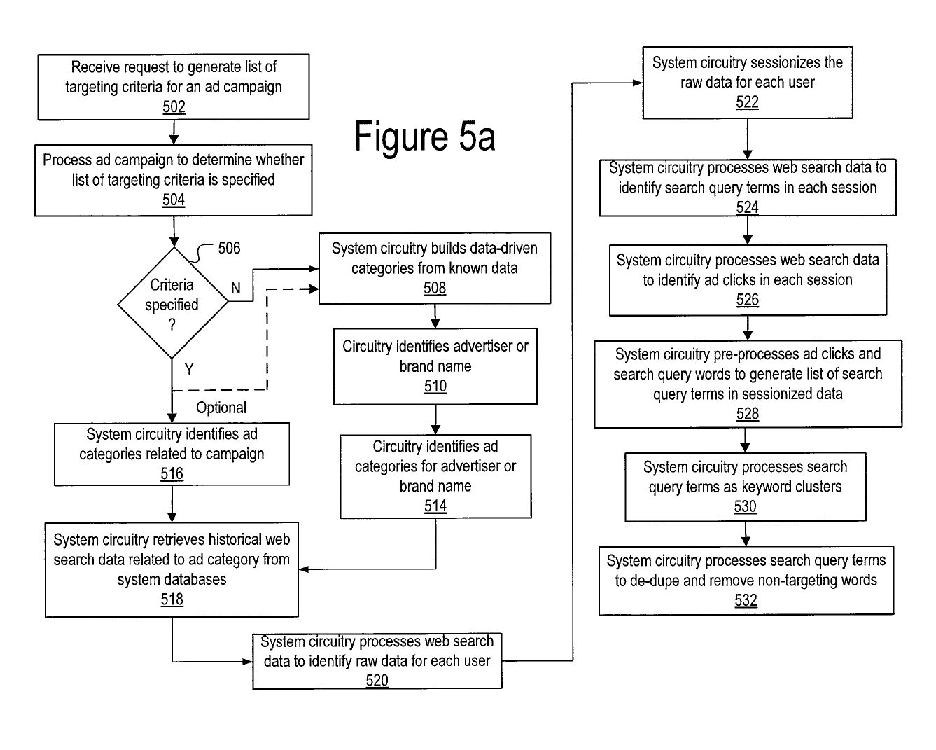

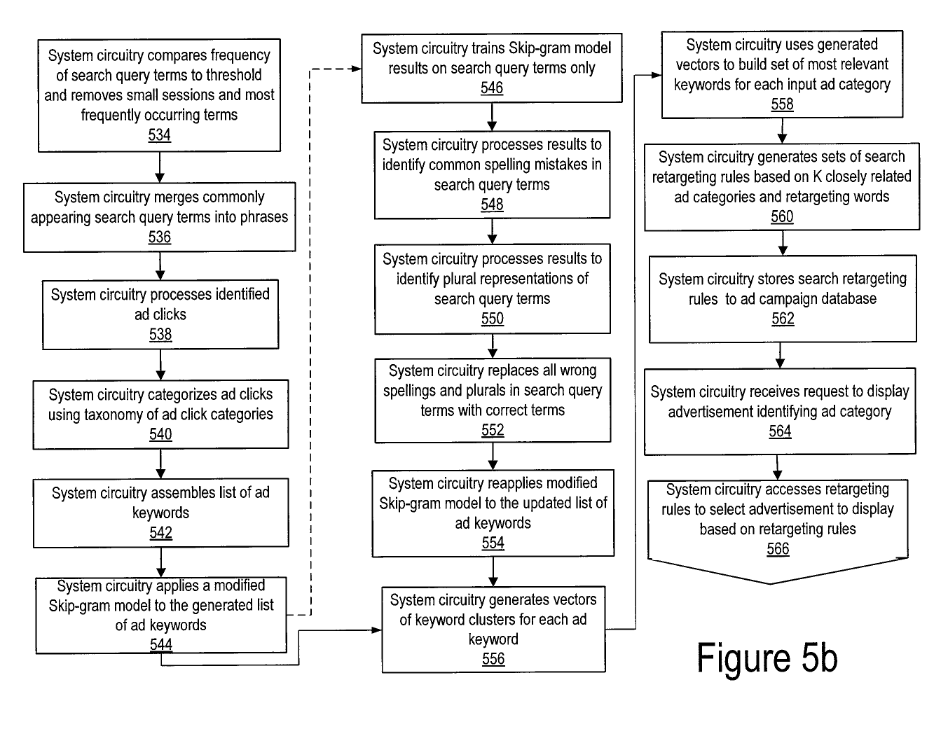

Periodically or at predetermined intervals, keyword vector generator 200 will process the web search activity communicated by search retargeting server 116 and will generate or update keyword lists for various ad campaigns. In addition or alternatively, the keyword vector generator 200 may also generate a keyword list for an ad campaign, advertiser, or ad category associated with the campaign or advertiser, in response to a request received by search retargeting server 116. Upon receipt of the request, retargeting circuitry 202 will communicate the request to modeling circuitry 204. As described further in connection with FIGS. 4 and 5, modeling circuitry 204 pre-processes the data to prepare it for modeling by modeling circuitry 204 using one or more modified linguistic modeling or statistical natural language processing techniques, such as a modified bigrams and n-grams approach. In one embodiment, a modeling technique based in-part on the skip-gram linguistic modeling technique may be adapted, modified, and used in order to provide statistical correlation between ad clicks and search query terms with associated keywords. Generally speaking, skip-grams are a generalization of n-grams in which the components (typically words) of a field of text (typically an article or document input into the computational algorithm) are not required to be in consecutive order to be considered and processed by the algorithm. In this way, the computational analysis can bypass or “skip” gaps of text while processing the text of the article.

In some embodiments, modeling circuitry 204 uses computational linguistic analysis techniques that utilize aspects of skip-gram modeling to process web search activity. Instead of processing word and documents, the modified modeling program processes historical web search activity, treating ad clicks and search queries in a manner akin to how one may treat words of a document in linguistic analysis. The modeling techniques are further adapted to consider time-related data associated with the web search activity, such that the algorithm is time-sensitive. In this way, the system circuitry, including modeling circuitry 204, can generate vector representations of keywords that are statistically indicative of the correlation between ad clicks, search query terms, and targeting keywords. In other words, modeling circuitry 204 generates vector representations of the likelihood that a keyword is related to a category of an advertisement that the keyword is likely to lead to an ad click.

Further, training circuitry 206 may use training data in order to derive a further optimize the probability distribution of the keywords that are most likely to result in an ad click. As illustrated in FIG. 2, in some situations, modeling circuitry 204 may communicate the data to training circuitry 206 for further optimization or modeling circuitry 204 may communicate the data directly to display logic circuitry 208 to generate display logic for a relevant advertisement. In one embodiment, the training circuitry 206 is access only when the initial distributed query representations of the associated keywords are first being generated. When search retargeting server 116 is attempting to serve an advertisement, on the other hand, retargeting circuitry 202 may access one or more models previously generated, including the lists of keywords generated for relevant advertising campaigns, in order to select an ad for display. In this scenario, modeling circuitry 204 may communicate directly with display logic circuitry 208 to generate the necessary display logic for displaying the ad to the user.

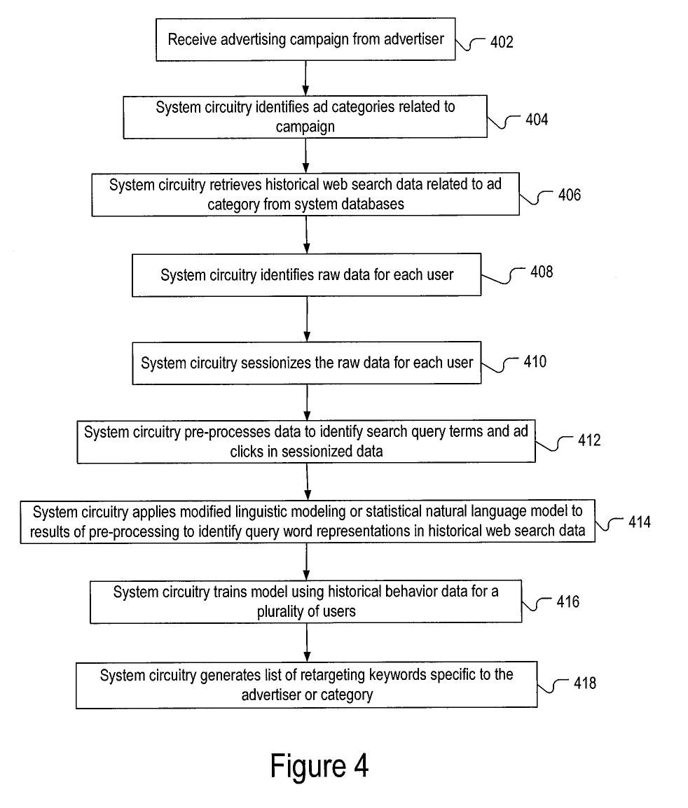

FIG. 3 illustrates a block diagram of one embodiment of exemplary monetization circuitry of a search retargeting server, including monetization circuitry that may be utilized in connection with selecting a targeting keyword from a list generated from distributed query representations. Search retargeting server 300 (which may be the same server as search retargeting server 116 or ad server 118, or a separate server communicatively coupled to ad server 118 or search retargeting framework server 116 over a network) may include monetization circuitry 302 for monetizing keyword lists generated using distributed query word representations. Monetization circuitry 302 may include component circuitry consisting of one or more of bidding circuitry 304, analytics circuitry 306, retargeting circuitry 308, keyword generator circuitry 310, and GUI circuitry 312. Monetization circuitry 302 is in communication with ad database 320 and search history database 322, which, in some embodiments, may be the same database as ad database 110, content database 114, account database 104, or analytics database 119, or may be in communication with one or more of these databases over a network, such as network 120.

Search retargeting server 300 may provide a GUI accessible over the network that allows an advertiser to access the server and to create advertising campaigns, for example. The server interface may include graphical elements generated by GUI circuitry 312 that allow the advertiser to specify campaign parameters, including advertiser information, campaign information, targeting criteria, bid amounts, campaign categories, advertiser categories, keyword lists, as well as provide any other function associated with creating an advertising campaign in accordance with the present description. Advertisers may include organizations wishing to advertise a product, a set of products or related categories of products, services, or events, owners or aggregators that want to drive user visits to their sites (which may be related to other entities), developers of content, such as smart phone applications, service providers, and any other entity that may wish to be associated with a set of keywords for search retargeting.

Any of these advertisers may access search retargeting server 300 and generate an advertisement campaign. The ad campaigns will be stored in ad database 320 and accessible by search retargeting server 300. During generation of an advertisement to display in response to a search query, the content request will be communicated to search retargeting server 300. Monetization circuitry 302 will process the content request to identify a category associated with the request. The category may identify which product area or set of advertisers are relevant to the content request. For example, the category may include sports, finance, technology, healthcare, automobile, beverage, and so forth. The monetization circuitry 302 will determine which advertiser groups are most relevant to the content request. This may include analytics circuitry 306 determining one or more contexts and/or keywords associated with the content request and selecting the most relevant ad campaigns for each context. For each content request, there may be multiple advertising opportunities and the same of different contexts and relevant campaigns can be determined for each.

For each of campaign determined to be relevant, monetization circuitry 302 and bidding circuitry 304 can select multiple bids from the advertisement campaigns in ad database 320 and generate GUI elements for ad content associated with the advertisement campaigns. Bidding circuitry 304 collects all of the bids for keywords that may be relevant to the content request. Retargeting circuitry 308 then determines which retargeting keywords, and thus which campaigns, are most relevant to content request, including taking into account any contexts or categories associated with the content request. Retargeting circuitry 308 may utilize a number of algorithmic techniques in order to assess the relevance of the search results to the keywords and contexts associated with the content request. In some embodiments, retargeting circuitry 308 may identify a query word contained in the content request and match the keyword to keyword lists previously generated for an advertiser, product, or category of products. In additional embodiments, the keyword lists may be generated in response to receiving the content request and in order to identify which keywords are relevant to the contest request as it is received.

Retargeting circuitry 308 may also communicate with analytics circuitry 306 to process historical data related to historical user interactions with content, such as ad clicks, click through rate, bounce rate, or any of the targeting data, in order to generate distributed query representations as described further in connection with FIGS. 4 and 5. Once retargeting circuitry 308 has identified the distributed query representations, keyword generator circuitry 310 may generate a list of the most relevant keywords for a set of advertisers or for an ad category. These lists can be used by bidding circuitry 304 to select a relevant advertisement campaign. Bidding circuitry 304 will consider the bid amounts for each of the relevant keyword and select the winning bids, which may be the highest bid for one of the relevant keywords.

As mentioned, search retargeting server 300 may identify multiple advertisement opportunities in connection with a single page display. In this case, all of the ads which match the keywords related to the content request (including the contexts and search query terms), are bid against each other, and a separate auction can be held for each of the advertisement opportunities. The system circuitry can consider bids for keyword, but can also take into account which bids have specified targeting criteria that are more relevant to the search query term or context of the content request. Thus, each advertisement opportunity can be auctioned by evaluating combined factors considering the keyword as well as the context of the content request. The additional contexts that may be identified for a particular query, include user demographics, profile traits, search history, geographic location data associated with the search query, and so forth. These contexts may be matched to keywords to provide further sets of ads to be used for an advertisement opportunity.

FIG. 4 illustrates exemplary operations that may be performed, according to one embodiment, by the circuitry of a search retargeting server in an exemplary system in order to generate distributed query representations to be used for search retargeting. At block 402, the advertiser accesses the system interface of the search retargeting server (or ad server) and creates an advertisement campaign. Alternatively, or in addition, the advertiser may submit an existing campaign having an existing keyword list or set of keywords used for retargeting. In the first scenario, the advertiser may, for example, be interested in generating a keyword list from scratch for a new advertising campaign. In the second scenario, the advertiser may be interested in expanding or improving the existing keyword list for one or more campaigns. For example, the advertiser may have been using a generic keyword list for all ads of particular category, e.g., travel, and now wishes to improve the keyword list using the most recent data stored by the system or wishes to design a more detailed set of keyword lists tailored to a more targeted ad group or category, such as for travel to a particular destination.

At block 404, the system circuitry identifies one or more ad categories related to the campaign. As illustrated in the previous examples, the category may be related to a specific product or advertiser, or may be related to a class of products or advertisers. Exemplary categories for classes of products may include high-level categories, such as food, clothing cards, personal electronics, theatres, television, produce, services, tools, household products, furniture, computer equipment, automobiles, healthcare, personal care, and so forth. Exemplary categories for specific products or advertisers, on the other hand, include keywords related to a single product, brand name, or manufacturer. The categories for campaigns generally identify which search activity the advertiser is interested in targeting. For example, a travel booking agency may be interested in the categories of ad campaigns associated with air tickets, hotels, car rentals, train tickets, and so forth. The categories are often based on market research and include standard sets of keywords that advertisers use for campaigns. For example, the advertiser may have a set of keywords that uses for all “travel” related ads. In other examples, the categories may include keywords associated with competing brands and manufacturers that the advertiser wishes to use to retarget. Beginning with the step at block 404, the system may start with the determined ad category, optionally including any generic list of keywords related to the category provided by the advertiser, and produce a more comprehensive, exhaustive, and highly targeted list of ad keywords.

At block 406, the system circuitry retrieves historical web search data related to the identified ad category from the system databases, such as account database 104, ad database 110, content database 114, and analytics database 119. At block 408, the system circuitry identifies the raw data for a particular user from the web search data. The raw data may include historical advertising campaigns for a number of advertisers and the text of the advertisements themselves, as well as users' prior search queries, ad clicks, ad conversions. As previously mentioned, the web search data is typically aggregated on a per-user basis in order to form profiles for targeting. For example, raw activity logs of search queries with timestamps may be stored for every user. The activity for each user is recorded as one record in the activity logs. The system may retrieve all web search data for a recent period of time, such as for the past six months, and examine the data on a per-user basis to determine keyword relevancy to the particular user.

At block 410, the system circuitry, such as analytics circuitry 628 or one or more components of pre-processing circuitry 634 described further in connection with FIG. 6, sessionizes the raw data for each user using timestamps associated with the data. In one embodiment, the data may be sessionized based on a predefined timeline or series of events as conceptually indicated by the data itself. For example, a single session of data may conceptually begin when the first search query word is entered by the user. Once there has been no activity in the web search data for some period of time (e.g., thirty minutes), as determined by examining timestamp data within the web search activity data, the system ends the session and stops tracking the data for that particular session. Once a session ends, the system continues process data until the appearance of the next search query, in which case the system records a second session. In this way, a series of sessions for each user are identified where each session begins with a search query and encompasses the sequential actions or activities taken by the user following that search query. The data between the sessions can be skipped or discounted to account for the decreased likelihood that the data is relevant to a resulting ad click.

At block 412, the system circuitry pre-processes the data to identify search query terms and ad clicks in each session of the sessionized data. As described further in connection with FIGS. 5a and 5b, a number of pre-processing steps may be utilized by the system circuitry in order to allow the system to more properly identify keyword representations at block 414 using modified linguistic analysis techniques. Conceptually, the pre-processing steps are generally designed to take into account distinctions between web search data and search query terms as contrasted to natural languages. For example, while conducting searches online, users often use a different semantic structure than used in common natural language parlance. In particular, users often reverse or modify sentence and verb structure. For example, a user searching for a vacation in France, for example, may search for “summer vacations France” or “France summer vacation.” In common parlance or writings, on the other hand, the same person may say “I am interested in a vacation this summer in France.” Thus, the processing of web search data using computational linguistic and natural language analysis techniques can be improved by account for these and other nuances. Similarly, when searching for websites, the user often writes the entire website name without spaces. Consequently, in order to more efficiently apply natural language processing techniques to web search data, it is beneficial to account for these and other differences by considering search query terms both forward, backwards, and the various permutations thereof, as well as parsing the query for sub-component query terms.

At block 414, the system circuitry applies one or more modified linguistic modeling or statistical natural language processing techniques, such as a modified skip-gram model in some embodiments, to the results of the pre-processing in order to identify distributed query word representations in the historical web search data. In some embodiments, the distributed query word representations consist of associations between search query terms and ad clicks to the actions of a user. For example, the distributed query word representations may represent a likelihood that a user will perform a given action (e.g., click on a displayed ad related to a particular category) after the user enters a search query containing a particular keyword. Traditional natural language processing techniques may typically involve one or more algorithms performed on an article, set of articles, or similar body of text that are input into to the algorithm and treated as “documents.” Each “word” in the document is then analyzed to determine the statistical relevance. For sake of illustration, as part of block 414, the processing techniques have been modified conceptually to treat each search query term or ad click in the sessionized and pre-processed data as a “word” and to treat each session of data as a “document” or similar body of text. In this way, natural language processing techniques have been adapted, modified, and extended to be effective in analyzing web search data. These techniques allow the system to generate distributions of search query representations using the historical web data and one or more modified linguistic processing models at block 414. At block 416, the models are further modified or trained based on training techniques to account for unique issues raised by processing web search data. For example, in some embodiments, phrases or sets of words that often appears together either because they are a compound term or because they are the result of a spelling mistake are treated similarly. In this way, commonly associated words (e.g., plurals, misspellings, different tenses) can be grouped and treated as identical for purposes of keyword prediction. Further pre-processing and training techniques of some embodiments are discussed in connection with steps 528-554 of FIGS. 5a and 5b.

At block 418, the system circuitry generates a list retargeting keywords specific to the advertiser that submitted the campaign at block 402 or the ad category identified at block 404. In some embodiments, the result of steps 414 and 416 is in the form of a vector representing the keyword distributions as related to the input category or advertiser. In these embodiments, as well as others, the keywords that are most closely related to the input advertiser name or ad category are represented in the vector as being nearest to the advertiser name or ad category. In this way, the set of the most closely related keywords in the vector representations can be selected as having the highest likelihood that they are indicative or predictive of an ad click. In addition, in some embodiments, the system circuitry may generate a set of retargeting rules using the keyword list and the closest K neighbors in the list to be used in conjunction with search retargeting techniques. Given one or more search retargeting rules and a list of closely related keywords generated by the system circuitry according to these steps, such as by the circuitry components of keyword vector generator 200 of FIG. 2 or search retargeting circuitry 612 of FIG. 6, the system is able to identify ad impression opportunities that are closely related to the advertiser or the ad category, and to facilitate monetization of the search query via search retargeting using the identified keywords.

FIGS. 5a and 5b illustrate exemplary operations that may be performed by the circuitry of an ad server and/or a client-side application of a user in an exemplary system in order to generate search retargeting rules using distributed query word representations. Although depicted as separate steps and in a sequential matter, a person having ordinary skill in the art will recognize that some steps may be combined with other steps, or omitted entirely in some embodiments, and that individual steps or series of steps may be reordered without necessarily departing from the spirit and scope of the present description. At block 502, the advertising system receives a request to generate a list of targeting criteria for an advertisement campaign. The request may contain one or more advertisement campaigns, as well as the targeting criteria for each campaign. Further, each advertisement campaign may have campaign data associated with the campaign describing the category of ad impression opportunities that the campaign relates to. At block 504, the system circuitry processes each campaign in the request to determine whether a list of previously created targeting is specified for the campaign. For example, a list of previously created targeting criteria may be specified when an advertiser has previously generated an ad campaign for a particular product or server, set of products or services, and/or category of products or services. A list of targeting criteria may not haven specified, on the other hand, if the advertiser is seeking to generate a list of targeting criteria and keywords for a campaign from scratch. In this scenario, the advertiser may still provide one or more categories of products or services that it is interested in targeting, or the system may determine the one or more categories of products for the advertiser based on the advertiser name or names of their popular products. For example, in some embodiments, the system circuitry may query the system databases to obtain historical campaign data for the advertiser or major products of the advertiser. The system analytics tool may analyze this information determine one or more categories prevalent in the data. At block 506, the system circuitry determines whether criteria have been specified, and if not, proceeds to block 508. Similarly, in some embodiments, even if targeting criteria have been identified at block 506, the system may optionally proceed to block 508 to identify additional categories related to the advertiser, or its products and services, for targeting from existing web search data, as previously described.

At block 508, the system circuitry builds a set of data-driven categories from known data associated with the advertiser. For example, at block 510, the system may identify the name of the advertiser or one or more brands associated with the products and services of the advertiser. In other embodiments, if the existing targeting criteria were provided by the advertiser then the system may identify categories of products and services associated with the advertiser by analyzing the existing campaign and historical search data for the advertiser and products, as well. As non-limiting examples, the categories for a given advertiser may include product areas, such as “sports,” “travel” “automotive,” “technology,” “entertainment,” “finance,” and so forth. The categories may also include one or more sub-categories of products and services provided by the advertiser, as well as subsets of product brands in each sub-category. At block 514, the system circuitry identifies the set of related categories for the advertiser, as well as its associated brands and products, as ad categories for the advertiser. If a set of criteria were specified by the advertiser at block 506, then the system proceeds to block 516 where the system circuitry identifies the ad categories specified by the advertiser as part of the targeting criteria (e.g., as part of its existing search retargeting rules). The system may also extrapolate the categories specified by the advertiser to other known categories associated with either the advertiser itself, or the categories related to the criteria specified by the advertiser. For example, the system may access historical query word representations that have previously been generated by the system to determine product and service associations between the advertiser's products or associations between the advertiser's products and those of other advertisers in the industry, such as the advertiser's competitors.

At block 518, the system circuitry retrieves historical web search data related the identified ad categories from the system databases. By way of illustration, the historical web search data may include historical search queries entered by users, historical advertising campaigns, recorded ad clicks or interactions with ad content, ad impressions, and resulting ad conversions, for example. The system circuitry may obtain web search data from sources over the network 120 by communicating with one or more distributed databases, such as obtaining web search data from the search engine server 106, the ad server 108, the ad database 110, the content server 112, the content database 114, the search retargeting framework server 116, the sponsored search server 117, the analytics server 118, and/or the analytics database 119. At block 520, the system circuitry processes the retrieved web search data to identify the raw data for each user. As described in connection with FIG. 4, the web search data is typically aggregated on a per-user basis in order to form profiles for targeting. For example, raw activity logs of search queries with timestamps may be stored for every user. The activity for each user is recorded as one record in the activity logs. The system may retrieve all web search data for a recent period of time, such as for the past six months, and examine the data on a per-user basis to determine keyword relevancy to the particular user. In this way, the system can ultimately generated targeted keyword lists for a particular user, or set of users determined to be similar based on known profile traits, in order to provide search retargeting rules that target the particular user or set of users having similar traits.

At block 522, the system circuitry sessionizes the raw data for each user. The data may be sessionized based on a predefined timeline or series of events as indicated by the data itself. For example, a single session of data may conceptually begin when the first search query word is entered by the user. Once there has been no activity in the web search data for some period of time (e.g., an hour), as determined by examining timestamp data within the web search activity data, the system ends the session and stops tracking the data for that particular session. As part of the sessionizing process, at block 524, the system circuitry processes the web search data to identify search query terms submitted by the user during each session, such as by using a search query box on a search engine or an embedded query text field feature on a webpage or network browser. Similarly, at block 526, the system circuitry processes the web search data to identify ad clicks and click activity of the user during each session. In this way, the system circuitry creates a catalogue of a web search and ad click activity for the user within each of the determined user sessions.

At block 528, the system circuitry pre-processes the ad clicks and search query terms to generate a list of query terms in the sessionized data. As described in connection with FIG. 4, processing techniques have been modified conceptually to treat each search query term or ad click in the sessionized data conceptually as a “word” in natural the language processing techniques discussed herein and to treat each session of data as a “document” or similar body of text. At block 530, the system circuitry processes the list of search query terms as a set of keyword clusters in order to account for the different semantic structure commonly used in search queries that differs from that commonly used in everyday natural language parlance, such as described further in connection with step 414 of FIG. 4. At block 532, the system circuitry processes the list of query terms to de-dupe the list and remove non-targeting words. For example, in some embodiments, the system circuitry will identify cluster of repeating queries for the same search query term and merge them into group. For instance, if a user searched for “golf shoes” and then waited a period of time before searching for “golf sneakers” again (e.g., on a different website or search engine), then both queries will show up within the web search data as separate queries and each will trigger a new session. The most predictive actions to be influential in targeting the user, however, likely occurred between the two searches and thus should be considered together. Moreover, natural language processing techniques are inherently sensitive to the situation where multiple queries for the same query are entered in succession and processing these queries separately would likely introduce inconsistencies in the model in some embodiments. Thus, in order to account for these situations, the system circuitry identifies repetitive query term entries (whether entered on the same webpage or domain or multiple), including slight various thereof (e.g., plurals or closely related synonyms), and merges the session date for each of query entries into a single session so that they data may be considered together without exerting undue influence on the process.

At block 534, the system circuitry compares the frequency of the search query terms to a threshold indicator and removes all sessions of data that are too small to accurately be predictive of user actions, as well removing as the most frequently occurring terms, which are often connectors such as “the” and “and.” For example, in some embodiments, if the list of search query terms generated at block 528 contains only contains one search query term and no ad clicks, then the session will not be helpful to the statistical analysis because there is an insufficient amount of user actions within the session data (e.g., query term entries and ad clicks). Consequently, the system will not be able to, or at least inefficient at, determining the statistical significance of any related keywords based this session data. Thus, at block 528, the system circuitry may compare the session size to a threshold T and remove the session data for sessions that do not contain at least T amount of keywords or ad clicks. The size of T may be scalable in terms in relation to the amount of web search data drawn from, but in some embodiments the size of T=5 may be sufficient.

Similarly, at block 534, the system circuitry also compares the number of times a particular query term appears in the list of search query terms for each session and removes the most frequently appearing words. The most frequent words, such as “the,” “and,” etc., are typically less informative to the statistical process than are rare words entered by the user. Moreover, these common words often occur in the direct neighborhood of the majority of other words, which creates a risk that learning these relations will results in lower quality distributed word representations as these common words would appear to be related to other keywords. For this reason, at step 534, the most common words are discarded. In some embodiments, the common words may be discarded by using the probability determination with:

$$P ( {w}_{i} ) = 1 - \sqrt{\frac{T}{f ( {w}_{i )}}}$$

where f(wᵢ) is the frequency of word wᵢ and T a constant parameter, which in some embodiments, may be set to 10⁻⁵, although other probability determinations will be apparent to those having skill in the art and such variations are intended to be included within the scope and spirit of the present description.

At block 536, the system circuitry mergers commonly appearing search query terms into phrases. In natural language as in the web search, it is common that certain words appear together more often than others, such as “credit card,” for example. Conceptually, the primary purpose of step 536 is to first find words that appear frequently together in some contexts, and infrequently in other contexts in order to make a determine that the words consistently appearing together only in some contexts should likely be treated as a phrase. This is especially important for search query terms based on web search data (i.e., as opposed to those in the list generated at step 528 based on ad clicks), where users often enter queries containing more than one word and will often change the semantic ordering. Thus, at step 536, the system circuitry counts the appearances for each word combination, such as by using unigram and bigram approaches in some embodiments, and for each word combination calculates the score for the combination. In one exemplary embodiment, the score for the word combination may be determined by the system circuitry by calculating a bigram score:

$$score ( {w}_{i} , {w}_{j} ) = \frac{( count ( {w}_{i} {w}_{j} ) - δ )}{count ( {w}_{i} ) \times count ( {w}_{j} )}$$

In these embodiments, bigrams with score above a pre-defined threshold are chosen to be treated together as a phrase or a single search query term (i.e., as a single “word” for purposes of the natural language processing), although other probability determinations will be apparent to those having skill in the art and such variations are intended to be included within the scope and spirit of the present description.

At block 538, in some embodiments, the system circuitry processes the identified ad clicks in the list of search query terms to categorize the clicks for use with the computational linguistic techniques. For example, at block 540 the clicks may be automatically categorized into a hierarchical taxonomy of categories using an automatic categorization system in order to assist in the linguistic processing of the click data. The taxonomy of categories may be predefined or generated by the system by analyzing the natural language relationship between categories and individual keywords. As will be recognized by one having ordinary skill in the art, this step is unique to the application of natural language processing techniques to web search data, which seeks to analyze the effect of ad clicks in conjunction with web search activity. In particular, by classifying the ad clicks into a hierarchical taxonomy of categories, the system further extrapolates ad click data to related ad category information and provides additional information to be used in generating more tailored and representative distributed query word representations from the web search data. In one embodiment, the automatic categorization system classifies the ad clicks into at least three levels of categorical words. The top level of categories include generic product categories for retargeting, such as “travel,” “retail,” “sports,” “technology,” “finance,” “health,” “automotive,” “entertain,” “politics,” “lifestages,” “issues and causes,” “small business,” “consumer packaged goods,” “telecommunications,” and so forth. The second level of categories may include particular brands, manufacturers, and retailers within the category. Finally, the third level of category may include specific products or services for each of the brands, manufacturers, and retailers, for example, although other arrangements are envisioned within the spirit and scope of the present description.

At block 542, the system circuitry categorizes the ad clicks the system assembles a list of ad keywords from the pre-processing steps for both ad clicks and search query terms. The list of ad keywords will consist of all of the categorized data for both search query terms and ad clicks present in each session of data. At block 544, the system applies one or more modified linguistic modeling or statistical natural language processing techniques to the results of the pre-processing in order to identify distributed query word representations in the historical web search data. In some embodiments, the system may apply a modified skip-gram model as described herein. In this case, the system circuitry will provide each sessionized sets of data for the user to be treated as a “document” in the modified skip-gram model. Similarly, each processed search query term and processed ad click identified in each session is analyzed by the system circuitry in a manner akin to the way in which a “word” within a “document” would be treated by the modeling techniques employed in traditional computational linguistics. The goal of processing the search query terms and ad clicks of the web search data using the modified skip-gram model is to identify a distribution of relationships between search query terms (including ad clicks) within the sessionized web data.

In addition to other modifications for pre-processing data and adapting the web search data to improve modeling results, the traditional operation of a skip-gram model is further modified to make it more appropriate for processing web search data. For example, in one embodiment, a skip-gram model may be adapted to be directed. Traditional computational linguistic techniques will typically consider words associations within a text-based document without consideration of whether the term comes before or after the word being examined in order to determine the relevance of the words to each other. In other words, the elements of a document are not treated differently for analytical approach based on their location within the document. However, in web search activity, the primary focus is on the data immediately preceding an ad click as, conceptually, this is most likely to be representative of why the user clicked on the ad. Thus, some embodiments further adapt the skip-gram modeling techniques to make the process directed such that it considers only the preceding actions within a certain distance the ad click. While this approach would not make sense in a traditional skip-gram modeling, the modification results in improved distributed representations for web search data due in part to the unique nature of web search activity.

Additionally, in some embodiments, the web search activity may be weighted based on recency or distance in time from a particular ad click. Traditional skip-gram modeling treats neighboring words as positive when training models and random words as negative. The skip-gram model, however, may be further modified to be account for the issues encountered when analyzing web search data. In particular, instead of treating randomly appearing words as a negative training on the model, the modeling techniques can be adapted to weight more heavily the activity that is closest to an ad click as that activity is most likely to be correlated to the resulting click. For example, in some embodiments, queries terms appearing directly before an ad click may be treated as positive and queries that are farther away from the ad click can be treated according to a sliding scale where queries are weighted more negatively when appearing farther from an ad click in the sessionized data. Again, while it may not be beneficial to weight words based on recency in traditional skip-gram modeling because of all the words considered in traditional computational linguistics applications are in a single document, the modification produces improved distributed query word representations when analyzing web search activity.

Returning to FIG. 5, after applying the modified skip-gram model, the system may optionally proceed to steps 546-554 in order to further train and refine the model to account for the nuances of processing web search data. If the model has already been trained, however, the system circuitry may proceed directly step 556. At block 546, the system circuitry trains the modified linguistic model, which may be a modified skip-gram model, based on the search query terms present in the web search data only. These steps may be applied to the search query terms only as they account for a major source of the semantic issues present in the web search data that consist of query search terms that are not necessarily present with ad clicks. In particular, at block 548, the system circuitry processes the search query terms to identify common spelling mistakes. For example, in one embodiment, the Damerau-Levenshtein distance between two words may be used to identify misspellings. The Damerau-Levenshtein distance between two words is the count of operations needed to transform the first word into the second word, where operations include insertion, deletion, or substitution of a single character, as well as transpositions. For most words in the natural language misspellings are typically at distance 2 or less. Therefore, among the top 200 neighbors of a particular search query term the system is able to find those that are at distance 2 or less, for example, and treat them as misspellings of the same term for the purposes of processing the web search data. Similarly, at block 550, the system circuitry processes the results to identify plural forms of the same search query terms within each session. At block 552, once the misspellings and plurals are identified, the system can replace all wrong spellings and plurals with correct spellings or same form of the term and retrains the model using these changes to the list of search query terms in the list of ad keywords generated at block 542.

At block 556, the system circuitry generates vector representations of keyword clusters for each of the ad keywords assembled at step 542 and optionally modified at step 554. The vector for each ad keyword includes distributed representations for each of the ad keywords, including each of the search query terms and ad clicks identified in the web search data with the exception that any some of search query terms may have been modified or merged during pre-processing and training. At block 558, the vectors are generated and used to build an ordered list of the related ad categories or keywords that may be used for retargeting. In some embodiments, the vectors represent an ordered list of keywords (related ad categories and retargeting words) that are most correlated to the respective ad keyword in the list of ad keywords generated at 542. In this way, the closest appearing ad categories and retargeting words are the retargeting keywords that are most likely to result in an ad click when a user searches for the retargeting ad selection. Thus, at block 560, the system circuitry selects the K most closely related ad categories and retargeting words for the ad keyword and generates a set of search retargeting rules utilizing the related ad categories and retargeting words for SRT rules. Additionally, in some embodiments, the list of K most closely related ad categories and retargeting words may also be used to expand existing targeting keyword lists by adding the K nearest or most closely related keywords for the ad category to the existing list. Alternatively or in addition, the K most closely related ad categories and retargeting words may be selected and aggregated to create a set of retargeting keywords for a particular advertiser or product or service from scratch.

Steps 562-566 illustrate sub-steps that may be performed during monetization of the generated retargeting keyword lists according to some embodiments. At block 562, the system circuitry stores the generated search retargeting rules to an ad campaign database for use in future retargeting opportunities. In some embodiments, the ad campaign database may be the same database as ad database ad database 320 described in connection with FIG. 3 or as one or more of ad database 110, content database 114, and analytics database 119 described in connection with FIG. 1. At block 564, the system circuitry receives a request to display an advertisement in response to advertisement opportunity. The request may identify one or more ad impression opportunities and an ad category or targeting keyword associated with each ad impression or opportunity in the advertisement request. At block 566, the system circuitry accesses the search retargeting rules stored in the ad campaign database and selects an advertisement to display for each impression opportunity based on an application of the search retargeting rules to the identified ad category or retargeting keyword for that ad impression. For example, in some embodiments, the targeting circuitry may identify the search retargeting rule that is most relevant to the identified category or retargeting keyword. In other embodiments, the targeting circuitry may work in conjunction with monetization circuitry select an advertisement that has a winning bid associated with it and is related to the identified category retargeting keyword, as further described in connection with FIG. 3.

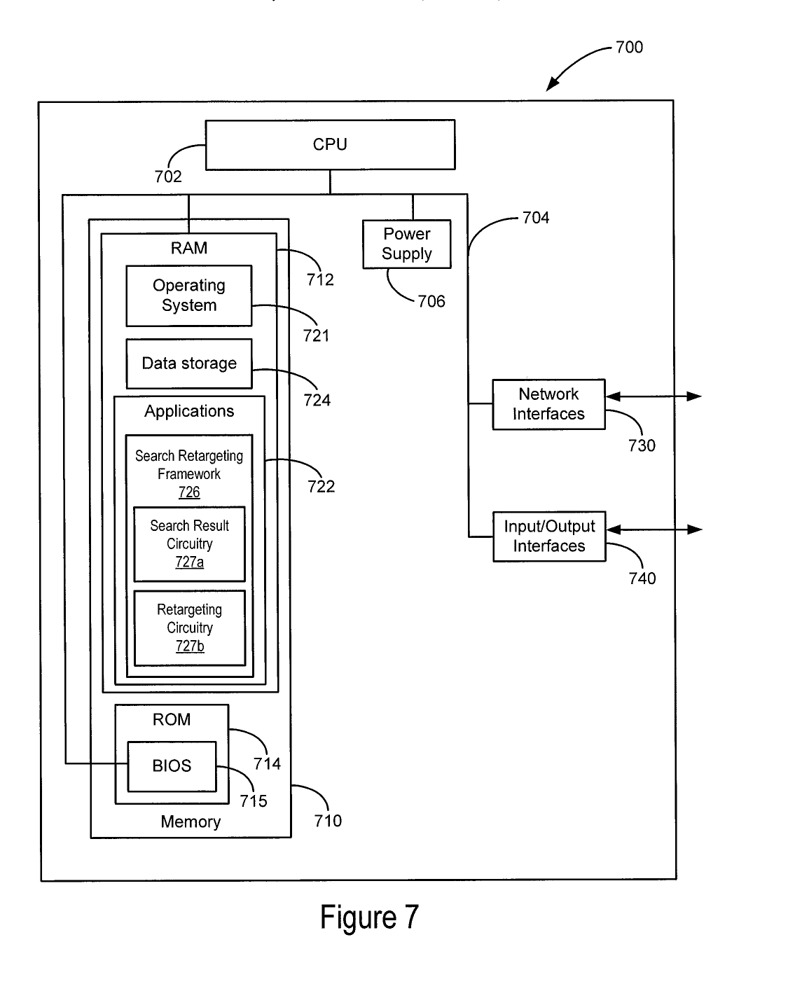

FIG. 6 illustrates a block diagram of example circuitry of a server of a system that can provide aspects of the module search object framework according to one embodiment, such as the search retargeting framework server 116 illustrated in FIG. 1. FIG. 13 also shows a client device 601 (which, in some embodiments, may be any of the client devices 124-128 described in connection with FIG. 1 and/or device 700 of FIG. 7) communicatively coupled to a framework server 600, over the network 120. Although depicted as a single server and component circuitry, in some embodiments, the server 600 may include one or more distributed servers and components communicatively coupled over a network, such as the search retargeting framework server 116, the search engine server 106, the ad server 108, the sponsored search server 117, the analytics server 118, or any combination thereof. The server 600 includes processor circuitry 602 and a system stored in a non-transitory medium 604 (such as a memory 710) executable by the processor circuitry 602. The system components are configured to provide several aspects of the framework described in the present description.

The system includes network communications circuitry 606 (such as circuitry included in the network interfaces 730) and framework circuitry 608 (such as circuitry included in the search retargeting framework 726). The network communications circuitry 606 and the framework circuitry 608 are communicatively coupled by circuitry. In the present disclosure, circuitry may include circuits connected wirelessly as well as circuits connected by hardware, such as conductive wires or traces through which electric current can flow. The network communications circuitry 606 may be configured to communicatively couple the system to the client device 601 over the network 120, which, in some embodiments, can be the Internet. This, for example, allows an ad to be selected by the server 600 and displayed by a client-side application installed on the client device 601.

The framework circuitry 608 includes search result circuitry 610 (such as search result circuitry 727a), search retargeting circuitry 612 (such as retargeting circuitry 727b), inter-search result interface circuitry 614, inter-retargeting interface circuitry 616, and inter-framework interface circuitry 618. The inter-search result interface circuitry 614 may be configured to communicatively couple any component circuitry of the search result circuitry 610. For example, the inter-search result interface circuitry 614 may at least communicatively coupled to one or more circuitry components, including search suggestion circuitry 622, webpage search result circuitry 624, configuration circuitry 626, analytics circuitry 628, monetization circuitry 629, maps circuitry 630, social media circuitry 631, and retargeting campaign generator 632. The inter-framework interface circuitry 618 may be configured to communicatively couple at least one circuitry component of search result circuitry 610 to any one of the plurality of circuitry components of search retargeting circuitry 612, including any of the individual components of pre-processing circuitry 634, modeling circuitry 636, training circuitry 638, and keyword generator 640. Each of the individual steps for processing of web search data to generate distributed query representations, as discussed further in connection with FIGS. 4-5b, may be performed the by one or more circuit components of framework circuitry 608, either individually or in conjunction. In particular, the functions described in connection with the steps of FIGS. 4-5b can be implemented via the interoperating of the sub-circuitry of the search result circuitry 610 and the search retargeting circuitry 612. The interoperating of the individual sub-components of search result circuitry 610 and search retargeting circuitry 612 may be facilitated by the inter-framework interface circuitry 618.

In an exemplary embodiment, a user may utilize user device 601 to submit a search query. The search query is transmitted over network 120 to server 600 received by network communication circuitry 606. The search query may be processed by processor circuitry 602 and communicated to framework circuitry 608. The framework circuitry 608 communicates the search query to one or more circuit components of search result circuitry 610 and search retargeting circuitry 612 where it is processed the respective circuit components of each. The components of search result circuitry 610 may generate search results related to the search query term. As part of this process, the search suggestion circuitry 622 may generate search suggestions related to the search query to display interleaved with the search results generated by webpage search result circuitry 624. The ordering and layout of the search results and suggestions, as well as other elements on the page, may be generated by configuration circuitry 626 and may consider user profile attributes and preferences retrieved from a user profile related to the user that submitted the search query using device 601. As part of the search results, one or more map features may be generated by maps circuitry 630. Similarly, one or more social features may be generated by social media circuitry 631 and displayed alongside search results with any map features. Additionally, one or more monetization opportunities for the search results may be determined by monetization circuitry 629. Monetization circuitry 629 may communicate each opportunity to the search retargeting circuitry 612 components in order to process the opportunity and to generate an advertisement using one or more retargeting rules.

The retargeting rules may be generated using computational linguistic techniques described in connection with FIGS. 2-5b and may be stored in one or more databases to be accessed by retargeting campaign generator 632 when serving an ad. Various features of the processes described in connection with the embodiments of FIGS. 4 and 5a and 5b, may be implemented by the circuit components of search retargeting circuitry 612. For example, pre-processing circuitry 634 may implement the process described in connection with steps 520-542 of FIGS. 5a and 5b and/or steps 408-412 of FIG. 4, and accompanying text. Modeling circuitry 636 may implement the processing steps described in connection with step 414 of FIG. 4 and/or steps 544 of FIG. 5b, and accompanying text. Training circuitry 638 may implement the processing steps described in connection with step 416 of FIG. 4 and steps 546-554 of FIG. 5b, and accompanying text. Keyword generator 640 (which in some embodiments may be the same circuitry components as retargeting circuitry of FIG. 2 or retargeting circuitry retargeting circuitry 308 of FIG. 3) may implement the processing steps described in connection with step 418 of FIG. 4 and steps 556-566 of FIG. 5b, and accompanying text. In some embodiments, each of these steps may also be performed by or in conjunction with one or more processors of the system. For example, in some embodiments, each circuitry component may consist of one or more processors particularly programmed to execute instructions for performing the described steps and tasks.

Additional beneficial functionality, such as retrieval of data specific to a user in order to generation session data for individual users, can be due to close coupling of the circuitry of the framework circuitry 608. Close coupling between client-side circuitry of the framework circuitry installed on the client device 601 and native operating system circuitry of the client device, circuitry of a client-side application installed on the client device, or both, can improve such beneficial functionality as well. In some embodiments, code can be communicated from the server 600 to the client device 601, which provides additional functionality to and configuration of the client-side circuitry of the framework circuitry for the client device. For example, circuitry and functionality within client device 601 may be added to or altered according to such code communicated from the server 600. The code may include objects representative of part of the framework circuitry 608.

The inter-retargeting interface circuitry 616 may be configured to communicatively couple at least one of the pre-processing circuitry 634, modeling circuitry 636, training circuitry 638, and keyword generator 640. The inter-retargeting interface circuitry 616 is communicatively coupled to the inter-search result interface circuitry 614 by the inter-framework interface circuitry 618. These interconnections can provide a basis for the communication and process of the web search data between the circuitry components as described in connection with FIGS. 4-5b and corresponding text.

The search result circuitry 610 also includes at least one component circuitry for implementing the functionality described in connection with FIGS. 2-5b. Other examples of module circuitry within the search result circuitry 610 can include search suggestion circuitry 622, webpage search result circuitry 624, configuration circuitry 626, analytics circuitry 628, monetization circuitry 629, maps circuitry 630, social media circuitry 631, retargeting campaign generator 632, and many more circuit components that may not depicted in FIG. 6 for sake of simplicity. Such circuitry can provide the various structures and operations illustrated and described in connection with FIGS. 2-5b. In some embodiments, the analytics circuitry 628 may provide for at least part of the information that is intended to be viewed by a user and may interact with aspects of an analytics server, such as analytics server 118, to improve feedback and the resulting content at least partially based on the feedback. The monetization circuitry 629 may be configured to record and communicate any user interactions with web content to the search retargeting circuitry 612 components.

The search result circuitry 610 may provide various functionalities and structures associated with retrieving and displaying sponsored and non-sponsored search results. The search suggestion circuitry 624 may provide various functionalities and structures associated with retrieving and displaying sponsored and non-sponsored search suggestions. The webpage search result circuitry 626 may provide various functionalities and structures associated with retrieving and displaying webpage search results, such as sponsored and non-sponsored search results. The maps circuitry 628 may provide various functionalities and structures associated with retrieving and displaying maps-based search results. For example, the maps circuitry 628 may include or be associated with navigation circuitry of the module circuitry 610 (such as circuitry for discovering routes and device geographic positioning and for providing navigational directions). The social media circuitry 631 may provide various functionalities and structures, such as GUI elements, associated with presenting social media information and providing social media applications on the results page, such as social media widgets. The social media circuitry 631 may be communicatively coupled over a network with servers of social media provides, such as TUMBLR®, LINKEDIN®, GOOGLE PLUS®, FACEBOOK®, TWITTER®, and the like. Information feeds and applications provided by the social media servers can be administrated by the social media circuitry for execution on sponsored and non-sponsored search results. The social media features as well as any other features described herein may be monetized, and the social media circuitry 631 may include its own circuitry dedicated to monetization.

Additionally, retargeting campaign generator 632 may be communicatively coupled to any of the aforementioned circuitry via inter-search result interface circuitry 614. Retargeting campaign generator 632 can process requests for advertisements associated with the search results generated by any of the aforementioned circuitry in order to generate advertisements using distributed query word representations as described in connection with FIGS. 2-5b. Display logic circuitry 642 is also communicatively coupled to the interface circuitry and dynamically generates, in response to the search query, the advertisement based on the distributed query word representations and retargeting rules to be displayed as a sub-portion of the root GUI associated with the search result page or other page displayed to the user.

As mentioned, each of the module circuitry may include sub-module circuitry, such as corresponding user interface circuitry, configuration circuitry, analytic circuitry, data processing circuitry, query processing circuitry, data storage circuitry, data retrieval circuitry, navigation circuitry, or any combination thereof. A complete listing of the various types of module circuitry and sub-module circuitry are numerous and beyond the scope of this application. The examples of module circuitry described herein and shown in FIG. 6 are merely illustrative of the expansiveness of the framework.

FIG. 7 is a block diagram of an example electronic device 700 that can implement server-side aspects of and related to example aspects of the framework. For example, the electronic device 700 can be a device that can implement the search retargeting framework server 116 of FIG. 1 or the server 600 of FIG. 6. The electronic device 700 can include a CPU 702, memory 710, a power supply 706, and input/output components, such as network interfaces 730 and input/output interfaces 740, and a communication bus 704 that connects the aforementioned elements of the electronic device. The network interfaces 730 can include a receiver and a transmitter (or a transceiver), and an antenna for wireless communications. The CPU 702 can be any type of data processing device, such as a central processing unit (CPU). Also, for example, the CPU 702 can be central processing logic.

The memory 710, which can include random access memory (RAM) 712 or read-only memory (ROM) 714, can be enabled by memory devices. The RAM 712 can store data and instructions defining an operating system 721, data storage 724, and applications 722. The applications 722 can include a search retargeting framework 726 (such as framework circuitry 608 illustrated in FIG. 6), which can include search result circuitry 727a (such as search result circuitry 610 and retargeting circuitry 727b (such as search retargeting circuitry 612). The applications 722 may include hardware (such as circuits and/or microprocessors), firmware, software, or any combination thereof. The ROM 714 can include basic input/output system (BIOS) 715 of the electronic device 700.

The power supply 706 contains power components, and facilitates supply and management of power to the electronic device 700. The input/output components can include the interfaces for facilitating communication between any components of the electronic device 700, components of external devices (such as components of other devices of the information system 100), and end users. For example, such components can include a network card that is an integration of a receiver, a transmitter, and I/O interfaces, such as input/output interfaces 740. The I/O components, such as I/O interfaces 740, can include user interfaces such as monitors, keyboards, touchscreens, microphones, and speakers. Further, some of the I/O components, such as I/O interfaces 740, and the bus 704 can facilitate communication between components of the electronic device 700, and can ease processing performed by the CPU 702.

As used in the present description, search engines may include Boolean search engines and semantic search engine techniques. The term “Boolean search engine” refers to a search engine capable of parsing Boolean-style syntax, such as may be used in a search query. A Boolean search engine may allow the use of Boolean operators (such as AND, OR, NOT, or XOR) to specify a logical relationship between search terms. For example, the search query “college OR university” may return results with “college,” results with “university,” or results with both, while the search query “college XOR university” may return results with “college” or results with “university,” but not results with both.

In contrast to Boolean-style syntax, “semantic search” refers a search technique in which search results are evaluated for relevance based at least in part on contextual meaning associated with query search terms. In contrast with Boolean-style syntax to specify a relationship between search terms, a semantic search may attempt to infer a meaning for terms of a natural language search query. Semantic search may therefore employ “semantics” (e.g., science of meaning in language) to search repositories of various types of content.

Search results located during a search of an index performed in response to a search query submission may typically be ranked. An index may include entries with an index entry assigned a value referred to as a weight. A search query may comprise search query terms, wherein a query term may correspond to an index entry. In an embodiment, search results may be ranked by scoring located files or records, for example, such as in accordance with number of times a query term occurs weighed in accordance with a weight assigned to an index entry corresponding to the query term. Other aspects may also affect ranking, such as, for example, proximity of query terms within a located record or file, or semantic usage, for example. A score and an identifier for a located record or file, for example, may be stored in a respective entry of a ranking list. A list of search results may be ranked in accordance with scores, which may, for example, be provided in response to a search query. In some embodiments, machine-learned ranking (MLR) models are used to rank search results. MLR is a type of supervised or semi-supervised machine learning problem with the goal to automatically construct a ranking model from training data.

In one embodiment, as an individual interacts with a software application, e.g., an instant messenger or electronic mail application, descriptive content, such in the form of signals or stored physical states within memory, such as, for example, an email address, instant messenger identifier, phone number, postal address, message content, date, time, etc., may be identified. Descriptive content may be stored, typically along with contextual content. For example, how a phone number came to be identified (e.g., it was contained in a communication received from another via an instant messenger application) may be stored as contextual content associated with the phone number. Contextual content, therefore, may identify circumstances surrounding receipt of a phone number (e.g., date or time the phone number was received) and may be associated with descriptive content. Contextual content, may, for example, be used to subsequently search for associated descriptive content. For example, a search for phone numbers received from specific individuals, received via an instant messenger application or at a given date or time, may be initiated.

Content within a repository of media or multimedia, for example, may be annotated. Examples of content may include text, images, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, etc.

A profile builder may initiate generation of a profile, such for users of an application, including a search engine, for example. A profile builder may initiate generation of a user profile for use, for example, by a user, as well as by an entity that may have provided the application. For example, a profile builder may enhance relevance determinations and thereby assist in indexing, searching or ranking search results. Therefore, a search engine provider may employ a profile builder, for example. A variety of mechanisms may be implemented to generate a profile including, but not limited to, collecting or mining navigation history, stored documents, tags, or annotations, to provide a few examples. A profile builder may store a generated profile. Profiles of users of a search engine, for example, may give a search engine provider a mechanism to retrieve annotations, tags, stored pages, navigation history, or the like, which may be useful for making relevance determinations of search results, such as with respect to a particular user.

Advertising may include sponsored search advertising, non-sponsored search advertising, guaranteed and non-guaranteed delivery advertising, ad networks/exchanges, ad targeting, ad serving, and/or ad analytics. Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

An “ad server” comprises a server that stores online advertisements for presentation to users. “Ad serving” refers to methods used to place online advertisements on websites, in applications, or other places where users are more likely to see them, such as during an online session or during computing platform use, for example. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system stored in a non-transitory medium executable by processor circuitry for generating retargeting keywords based on distributed query word representations, comprising:
one or more system databases storing historical web search data;
search retargeting circuitry that receives requests to generate sets of retargeting keywords related to one or more categories of an advertisement campaign;
pre-processing circuitry that retrieves a set of historical web search data related to the one or more categories of the advertisement campaign;
modeling circuitry that applies one or more computational linguistic models to the retrieved set of historical web search data and generates distributed query word representations from the retrieved set of historical web search data; and
keyword generator circuitry that generates a list of retargeting keywords related to the one or more categories of the advertisement campaign using the generated distributed query word representations.

2. The system of claim 1, wherein the historical web search data comprise historical search query terms submitted by users and ad click data related to user interactions with ad content.

3. The system of claim 1, further comprising a retargeting campaign generator that generates a set of search retargeting rules for the advertisement campaign based on the generated list of retargeting keywords.

4. The system of claim 3, further comprising monetization circuitry that receives a request to generate an advertisement specifying an ad category and applies one or more of the search retargeting rules to select an advertisement to display to a user.

5. The system of claim 1, wherein the distributed query word representations represent a likelihood that a user will click on an advertisement related to a particular category after the user enters a search query containing a keyword.

6. The system of claim 1, wherein the keyword generator circuitry further generates one or more vectors of keyword clusters of related keywords associated with the one or more categories of the advertisement campaign.

7. The system of claim 6, wherein the list of retargeting keywords is generated by selecting a predetermined number of the most closely related keywords associated with the one or more categories of the advertisement campaign.

8. The system of claim 1, wherein the one or more computational linguistic models comprises a model applying natural language processing to historical web search data.

9. The system of claim 8, the model applying natural language processing to historical web search data is based on a directed skip-gram model.

10. The system of claim 9, wherein the model based on the directed skip-gram model considers only user actions in the historical web search data that were taken within a predetermined timeframe of an ad click contained within the historical web search data for that user.

11. The system of claim 9, wherein the model based on the directed skip-gram model weights user actions in the historical web search data based on a timeframe proximity to an ad click contained within the historical web search data for that user.

12. The system of claim 1, wherein pre-processing circuitry further sessionizes the set of historical web search data by segmenting the data into a series of user sessions for each user.

13. The system of claim 12, wherein each user session in the series of user sessions comprises a series of ad clicks and search queries entered by the respective user within a predefined period of time.

14. The system of claim 12, wherein each user session in the series of user sessions begins with a user search query and ends after a predefined period of time.

15. The system of claim 2, wherein the modeling circuitry further trains the one or more computational linguistic models by processing the historical web search data to merge related forms of search query terms.

16. A computer-implemented method for generating retargeting keywords comprising:
processing, by search retargeting circuitry communicatively coupled to a network communications circuitry, a request to generate sets of retargeting keywords related to an advertisement campaign
processing, by pre-processing circuitry, the request to retrieve a set of historical web search data related to the advertisement campaign;
generating, by modeling circuitry, distributed query word representations from the retrieved set of historical web search data by applying one or more natural language processing models to the set of historical web search data; and
generating, by keyword generator circuitry, a list of retargeting keywords related to the advertisement campaign based on the distributed query word representations.

17. The computer-implemented method of claim 16, further comprising generating, by a retargeting campaign circuitry, a set of search retargeting rules for the advertisement campaign based on the generated list of retargeting keywords.

18. The computer-implemented method of claim 16, wherein the distributed query word representations associations between search query terms in the historical web search data and ad clicks of a user.

19. The computer-implemented method of claim 16, wherein the one or more natural language processing models applies to the historical web search data is based on a directed skip-gram model that only considers user actions in the historical web search data that were taken within a predetermined timeframe of an ad click.

20. A system for generating search retargeting keywords, comprising:
a means for receiving a request to generate retargeting keywords for an advertisement campaign;
a means for processing the request to identify historical web search data related to the advertisement campaign;
a means for generating distributed query word representations from the identified historical web search data by applying one or more natural language processing models to the identified historical web search data that considers user actions within a predetermined timeframe of an ad click; and
a means for generating a list of retargeting keywords related to the advertisement campaign based on the distributed query word representations.
